(19) United States
(12) Patent Application Publication
(10) Pub. No.: US 2020/0377069 A1
(43) Pub. Date: Dec. 3, 2020

(54) LINEAR BRAKING SYSTEM FOR RAIL VEHICLES

(71) Applicant: Norm Klassen, Parkland County (CA)

(72) Inventor: Norm Klassen, Parkland County (CA)

(21) Appl. No.: 16/430,346

(22) Filed: Jun. 3, 2019

(51) Int. Cl. B60T 13/36; B61H 15/00; B61H 13/00

(52) U.S. Cl. CPC B60T 13/365; B61H 13/005; B61H 15/0071

(57) ABSTRACT

The present invention relates to a linear brake assembly for a rail truck, comprising: a brake mechanism, the brake mechanism comprising at least one air brake, the air brake comprising at least a pressurized air chamber; a linear brake pad, the linear brake pad moveable between an extended position and a retracted position via operation of the brake mechanism, the extended position having the linear brake pad in contact with a rail and the retracted position having the linear brake pad not in contact with the rail; the linear brake pad defaulting to an extended position and moving to and from the retracted position via operation of the brake mechanism; wherein movement of the linear brake pad is performed via adjustment of air pressure within the pressurized air chamber of the air brake.

### FIELD OF THE INVENTION

The present specification relates generally to braking systems for rail vehicles and, more specifically, to a linear braking system for rail cars.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

An ongoing concern with the operation of railroad cars is the provision of comprehensive braking systems, including active braking systems and parking brake systems. Failure of the braking systems is the primary cause of most rail accidents, and can result in massive property damage and loss of life. Generally modern trains operate with a pressurized air braking system, which is vulnerable to failure when air pressure is lost, either rapidly or slowly, which prevents the brakes from being engaged. A particular risk is locomotive engine failure, as the locomotive engine commonly is used as the compressor system. To compensate, manual hand brakes are provided for application when the train is parked. However, setting of hand brakes must be done for each rail car, which is time consuming, difficult to track, and is still subject to risk, as often only a percentage of the hand brakes are set, based on the ratio of empty to loaded rail cars.

For example, the 2013 train derailment in Lac-Megantic, Quebec, Canada resulting in the deaths of nearly 50 people and the eventual destruction of the majority of the downtown of the city from the derailment and after-effects. One of the causes of the derailment was believed to be failure of the pressure in the air pressure system for the brakes, as well as having an insufficient number of hand brakes secured.

Accordingly, there remains a need for improvements in the art to partially or completely address the above-noted deficiencies.

### SUMMARY OF THE INVENTION

In accordance with an aspect of the invention, there is provided a to braking systems for rail vehicles and, more specifically, to a linear braking system for rail cars.

According to an embodiment of the invention, there is provided a linear brake assembly for a rail truck, comprising: a brake mechanism, the brake mechanism comprising at least one air brake, the air brake comprising at least a pressurized air chamber; a linear brake pad, the linear brake pad moveable between an extended position and a retracted position via operation of the brake mechanism, the extended position having the linear brake pad in contact with a rail and the retracted position having the linear brake pad not in contact with the rail; the linear brake pad defaulting to an extended position and moving to and from the retracted position via operation of the brake mechanism; wherein movement of the linear brake pad is performed via adjustment of air pressure within the pressurized air chamber of the air brake.

According to a further embodiment of the invention, there is provided a kit for a linear brake assembly for a rail truck, comprising: a brake mechanism, the brake mechanism comprising at least one air brake, the air brake comprising at least a pressurized air chamber; a linear brake pad, the linear brake pad moveable between an extended position and a retracted position via operation of the brake mechanism, the extended position having the linear brake pad in contact with a rail and the retracted position having the linear brake pad not in contact with the rail; the linear brake pad defaulting to an extended position and moving to and from the retracted position via operation of the brake mechanism; wherein movement of the linear brake pad is performed via adjustment of air pressure within the pressurized air chamber of the air brake; and one or more coupling mechanisms to secure the linear brake assembly to the rail truck.

According to a still further embodiment, there is provided a linear braking system for a rail car, comprising: a plurality of linear braking assemblies, each linear braking assembly comprising: a brake mechanism, the brake mechanism comprising at least one air brake, the air brake comprising at least a pressurized air chamber; a linear brake pad, the linear brake pad moveable between an extended position and a retracted position via operation of the brake mechanism, the extended position having the linear brake pad in contact with a rail and the retracted position having the linear brake pad not in contact with the rail; the linear brake pad defaulting to an extended position and moving to and from the retracted position via operation of the brake mechanism; wherein movement of the linear brake pad is performed via adjustment of air pressure within the pressurized air chamber of the air brake. wherein each rail truck on the rail car includes a pair of the linear braking assemblies.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a side schematic view of a rail car and rail trucks;

FIG. 2 is a side schematic view of a rail truck;

FIG. 3 is a side schematic view of a rail truck with a linear braking system attached according to an embodiment;

FIG. 4 is a side schematic view of the rail truck of FIG. 3 with the linear brake shoe retracted; and

FIG. 5 is a schematic of the linear braking system according to an embodiment.

Like reference numerals indicated like or corresponding elements in the drawings.

### DETAILED DESCRIPTION OF THE EMBODIMENTS

The present invention relates to braking systems for rail vehicles and, more specifically, to a linear braking system for rail cars.

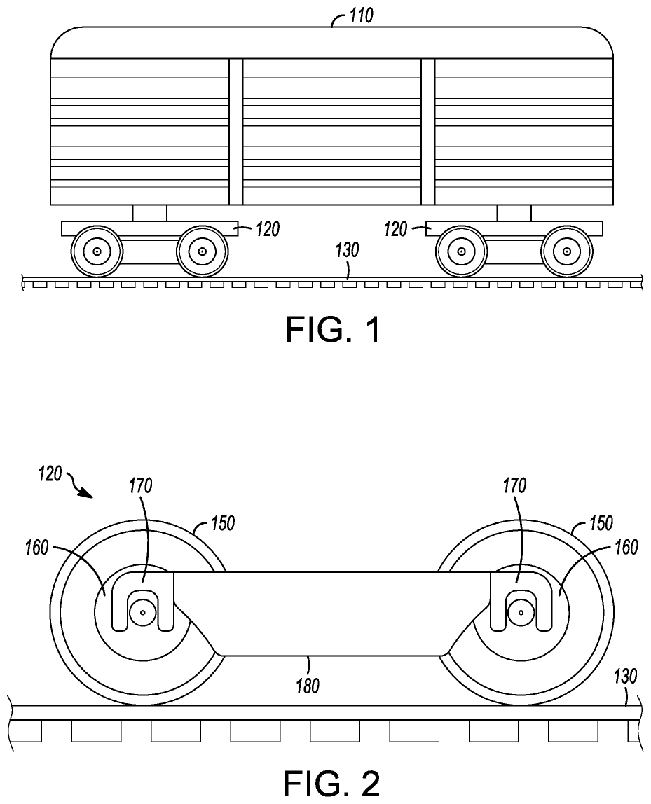

According to an embodiment as shown in FIG. 1, a rail car 110 is carried on trucks 120 over rails 130 for travel. As shown in more detail in FIG. 2, the trucks 120 comprise a set of wheels 150 with brake pads 160 and braking mechanism 170. In modern trains, braking mechanism 170 operates under air pressure, with the air pressure in the mechanism 170 increased to apply the brake pads 160 to the wheels 150. The body 180 of the truck may include a suspension mechanism (not shown), generally springs or air suspension, along with components for operating the braking mechanism 170, such as air hoses, valves and the like. Note the brake pads 160 are shown on the exterior of the wheels 150 for informative purposes, and brake pads 160 may be located on the interior of the wheels 150 in alternate designs.

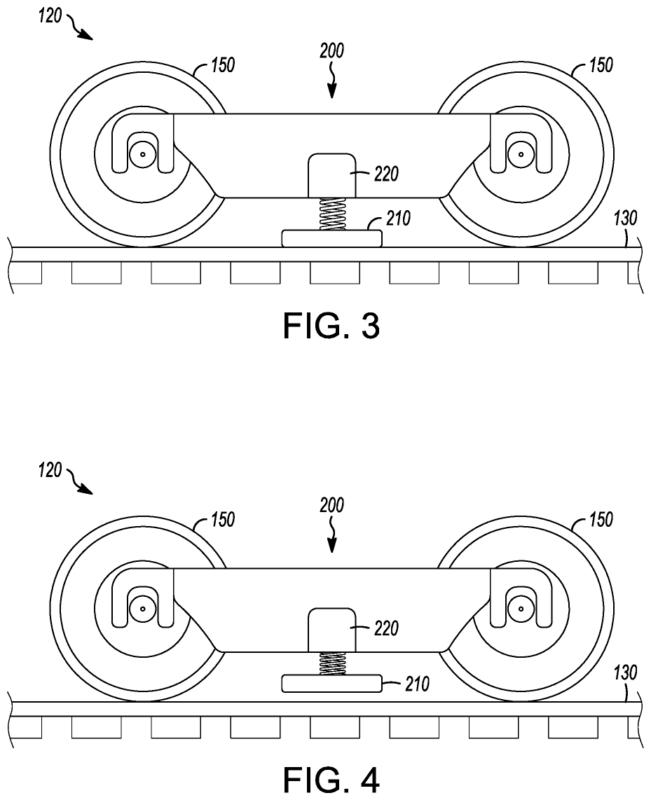

Referring now to FIGS. 3 and 4, a linear braking assembly 200 is attached to truck 120 over the existing body 180 to provide an additional braking option for the rail car 110. Linear braking assembly 200 may comprise a brake shoe 210 which extends to contact the rail 130 to brake or otherwise inhibit movement of the truck 120, and retracts off the rail 130 to permit movement. Extension and retraction are performed through the use of a spring brake 220, also known as an air brake, a maxi brake or a maxi pot.

The spring brake 220 is designed such the that default position, when there is no air pressure in the spring brake 220, is to extend the brake shoe 210 and engage the linear braking assembly 200. Brake shoe 210 is extended via a heavy-duty spring connected to the brake shoe 210, which forces the brake shoe 210 into contact with the rail 130. When air pressure is increased in the spring brake 220, the spring is compressed and the brake shoe 210 is retracted, disengaging from contact with the rail 130 and permitting movement of the truck 120 and rail car 110. Advantageously, if there is an air pressure failure while the brake shoe 210 is retracted, the spring decompresses and the brake shoe 210 is extended into contact with the rail 130, thereby providing a failsafe mechanism for the linear braking assembly 200. Accordingly, the risk of the truck 120 or rail car 110 moving unintentionally is reduced, avoiding a potential derailment or similar disaster.

Additionally, by having the linear brake shoe 210 engage in contact with the rail 130, as opposed to the wheel 150, risks of wear and wheel damage are mitigated, as any wear is applied to the brake shoe 210. Additionally, heat is dissipated by the rail 130, and fresh (unheated) sections of rail 130 are engaged as the truck 120 moves, thereby avoiding any warping of the wheel 150, as may be found with existing braking systems 170. Further, wear on the brake shoe 210 itself may be reduced, as the linear contact produces a more even heat distribution and wear pattern over the brake shoe 210.

As each rail car 110 runs on a pair of trucks 120, and each truck 120 has a pair of wheels 150 on either side, the rail car 110 requires four braking assemblies 200, two for each truck 120, mounted on each side between the wheels 150.

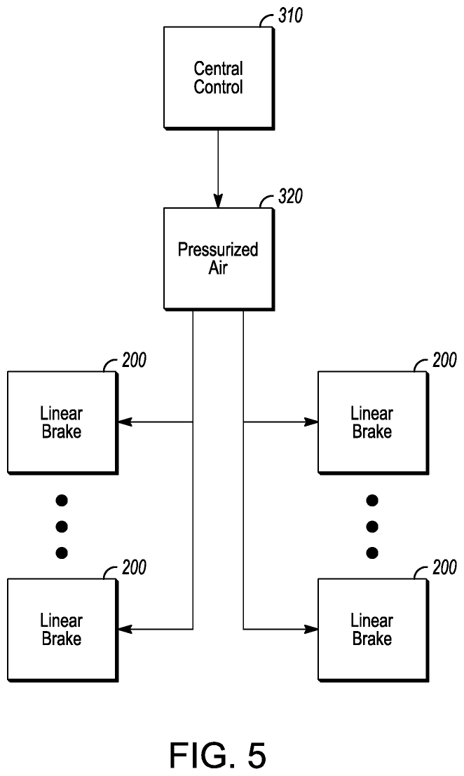

In operation, as shown in FIG. 5, each linear braking assembly 200 is connected to a source of pressurized air 320, preferably using the same source as the pre-existing braking system on the rail car 110. Further, each linear braking assembly 200 is communicatively coupled to a central brake control mechanism 310, which permits disengagement and engagement of all linear braking assemblies simultaneously. Preferably, again, the central control mechanism 310 is provided near to or combined with existing controls for the pre-existing braking system.

Advantageously, use of a central brake control mechanism provides for verification that the linear braking system is engaged, as well as ensuring that any disengagement of the linear braking system must be performed intentionally.

An emergency release mechanism may also be provided to depressurize and engage the linear braking assembly 200 in the event of a system failure or other emergency situation that requires the linear braking assembly 200 to be engaged. The emergency release may be integrated into the spring brake 220 to permit engagement of a single linear brake assembly 200. Alternatively, or additionally, an emergency release mechanism may be provided on the rail car, which engages all linear brake assemblies 200 attached to all the trucks 120 on a given rail car.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A linear brake assembly for a rail truck, comprising:
a brake mechanism, the brake mechanism comprising at least one air brake, the air brake comprising at least a pressurized air chamber and a spring;
a linear brake pad coupled to the spring, the linear brake pad moveable between an extended position and a retracted position via operation of the brake mechanism, the extended position having the linear brake pad in contact with a rail and the retracted position having the linear brake pad not in contact with the rail; the linear brake pad defaulting to an extended position and moving to and from the retracted position via operation of the brake mechanism;
wherein movement of the linear brake pad is performed via adjustment of air pressure within the pressurized air chamber of the air brake.

2. The linear brake assembly of claim 1, further comprising a communication connection from the linear brake assembly to a central brake control mechanism.

3. The linear brake assembly of claim 2, wherein the brake mechanism is comprised of two air brakes, each coupled to the linear brake pad.

4. The linear brake assembly of claim 1, further comprising a coupling mechanism to couple the linear brake assembly to a rail truck body.

5. The linear brake assembly of claim 4, wherein the coupling mechanism further comprises one or more connection assemblies to connect the linear brake assembly to an existing brake assembly on the rail truck.

6. The linear brake assembly of claim 1, further comprising an emergency release mechanism coupled to the air brake assembly operative to depressurize and engage the linear brake assembly.

7. A kit for a linear brake assembly for a rail truck, comprising:
a brake mechanism, the brake mechanism comprising at least one air brake, the air brake comprising at least a pressurized air chamber and a spring;
a linear brake pad coupled to the spring, the linear brake pad moveable between an extended position and a retracted position via operation of the brake mechanism, the extended position having the linear brake pad in contact with a rail and the retracted position having the linear brake pad not in contact with the rail; the linear brake pad defaulting to an extended position and moving to and from the retracted position via operation of the brake mechanism;
wherein movement of the linear brake pad is performed via adjustment of air pressure within the pressurized air chamber of the air brake; and
one or more coupling mechanisms to secure the linear brake assembly to the rail truck.

8. The kit of claim 7, further comprising a communication connection assembly to provide a connection from the linear brake assembly to a central brake control mechanism.

9. The kit of claim 8, wherein the brake mechanism is comprised of two air brakes, each coupled to the linear brake pad.

10. The kit of claim 7, comprising a pair of linear brake assemblies for coupling to a single rail truck.

11. The linear brake assembly of claim 7, wherein the coupling mechanism further comprises one or more connection assemblies to connect the linear brake assembly to an existing brake assembly on the rail truck.

12. The linear brake assembly of claim 7, further comprising an emergency release mechanism coupled to the air brake assembly operative to depressurize and engage the linear brake assembly.

13. A linear braking system for a rail car, comprising:
a plurality of linear braking assemblies, each linear braking assembly comprising:
a brake mechanism, the brake mechanism comprising at least one air brake, the air brake comprising at least a pressurized air chamber and a spring;
a linear brake pad, the linear brake pad moveable between an extended position and a retracted position via operation of the brake mechanism, the extended position having the linear brake pad in contact with a rail and the retracted position having the linear brake pad not in contact with the rail; the linear brake pad defaulting to an extended position and moving to and from the retracted position via operation of the brake mechanism;
wherein movement of the linear brake pad is performed via adjustment of air pressure within the pressurized air chamber of the air brake.
wherein each rail truck on the rail car includes a pair of the linear braking assemblies.

14. The linear brake system of claim 13, further comprising a communication connection from each linear brake assembly to a central brake control mechanism.

15. The linear brake system of claim 14, wherein the air brake is comprised of two air brakes, each coupled to the linear brake pad.

16. The linear brake system of claim 13, further comprising a plurality of coupling mechanisms to couple each linear brake assembly to a rail truck body.

17. The linear brake system of claim 16, wherein each coupling mechanism further comprises one or more connection assemblies to connect the linear brake assembly to an existing brake assembly on the rail truck.

18. The linear brake assembly of claim 13, further comprising an emergency release mechanism coupled to the air brake assembly operative to depressurize and engage the linear brake assembly.
